(19) United States
(12) Patent Application Publication
(10) Pub. No.: US 2007/0282692 A1
(43) Pub. Date: Dec. 6, 2007

(54) METHOD AND APPARATUS FOR MODEL DRIVEN SERVICE DELIVERY MANAGEMENT

(76) Inventors: Ellis Edward Bishop, Austin, TX (US); Tian Jy Chao, Bedford, NY (US); Pankaj Dhoolia, Uttar Pradesh (IN); Prashant Jain, Delhi (IN); Rajesh Jaluka, Poughkeepsie, NY (US); Santhosh Babu Kumaran, Peekskill, NY (US); Heiko Hary Ludwig, New York, NY (US); Ann M. Moyer, Woodstock, NY (US); Anil Nigam, Stamford, CT (US)

Correspondence Address: CAHN & SAMUELS, LLP, 2000 P. STREET, NW, SUITE 200, WASHINGTON, DC, 20036, US

(21) Appl. No.: 11/422,145

(22) Filed: Jun. 5, 2006

(51) Int. Cl. G06Q 30/00

(52) U.S. Cl. 705/26

(57) ABSTRACT

Disclosed is an apparatus and method for organizing a service request processing system. The method includes receiving operational model data from domain knowledge, receiving business performance model data from said domain knowledge, developing a solution model based upon said domain knowledge and other data, and implementing a service delivery platform to execute a service request for processing said service request.

### FIELD OF THE INVENTION

### Background

The following are know problems associated service delivery:

Service Delivery teams are manually coordinating the activities required to process service requests. Lack of process automation has adversely impacted the efficiency and quality of service delivery.

### Key Performance Indicators (KPIs) are not being tracked, leading to lack of understanding of business performance metrics.

### There are a large number of tools and applications used in service delivery, but these are not well integrated.

### End-to-end models of service delivery operations do not exist today.

### Global optimizations at the operational level are impossible without such models.

### Traditional approaches to process automation do not work for IT service delivery since these approaches are not dynamic enough to handle the level of flexibility service delivery operations demand.

Others have tried different approaches for providing services, such as the following prior art.

U.S. Patent Application 2002/0169649A1 discloses a method for automated and efficient provision of professional legal documents and services. The provision of legal forms to a user by a lawyer is facilitated over an electronic communications link. The method entails establishing a communications link to permit a lawyer to provide legal advice to a user, receiving payment for the legal advice based on user information, and restricting access by the lawyer to a portion of the user information to maintain anonymity. The method generates customized situation-specific legal documents directly to the user's computer, and it does so without the risk of conflicts of interest, thereby substantially simplifying and streamlining the rendering of legal advice to users. Immediate rich text format (rtf) document delivery is accomplished directly to a secondary browser window so that subscribers are free to modify the documents at will.

U.S. Patent Application 2004/0024627A1 discloses a Business Technology Relationship Model (BTRM) is a method for abstracting and modeling the relationships that exist between technical infrastructure components and specific business processes, resulting in a proprietary Business Technology Relationship Protocol. The method defines a dependency approach to technical infrastructure delivery and management by creating the 13 Layer BTRM Dependency/impact Hierarchy, a modeled understanding of the dependencies that specific business processes have on specific technical infrastructure components, including the interdependencies between modeled business and technical objects. When the resulting Relationship Protocol is placed into software, the BTRM Method improves the delivery and management of technology infrastructure and technology support services spanning a diverse set of industries and business disciplines.

U.S. Patent Application 2005/0203917A1 discloses a system and method designed to optimize the delivery of information on demand via wired or wireless connections. Dynamic information such as weather data can be delivered as compressed text, images, charts, buoy data, radar, GRIB files, and many more formats. Numerous continuously updated products can be delivered to a user of a client application on demand by the push of a button. The user can generate a batch folder having a list of data products to download. The data list in the batch folder can be requested from a server using a single command. The system and method can be configured to immediately connect to a server via a wireless connection or email, including satellite phone and HF/Pactor Radio, and downloads the requested data. After the download the client can be configured to automatically display the requested data.

U.S. Patent Application 2006/0069607A1 disclose tools and related methods for business organizations to quickly obtain, preserve and exploit new or improved assets, skills or capabilities that are important to growth and success. The tools and processes disclosed are adapted to preserve one or more target elements of an acquired target business organization by outsourcing those target elements during the integration period that follows the merger or acquisition. This outsourcing of one or more target elements during the integration period that necessarily follows a merger or acquisition deal creates various inherent advantages over the traditional merger, acquisition, or outsourcing approaches as described herein, and these advantages help to deliver benefits of the target element in speedy fashion and with undiminished quality.

U.S. Pat. No. 6,438,594 discloses a system, method, and article of manufacture are provided for delivering service via a locally addressable interface. A plurality of globally addressable interfaces and a plurality of locally addressable interfaces are provided. Access is allowed to a plurality of different sets of services from each of the globally addressable interfaces and the locally addressable interface. Each interface has a unique set of services associated therewith. The globally addressable interfaces are registered in a naming service for facilitating access thereto. Use of the locally addressable interfaces is permitted only via the globally addressable interfaces or another locally addressable interface.

### SUMMARY OF THE INVENTION

An exemplary feature of this invention is a method for organizing a service request processing system. The method includes receiving operational model data from domain knowledge, receiving business performance model data from said domain knowledge developing a solution model based upon said domain knowledge and other data, and implementing a service delivery platform to execute a service request for processing said service request.

Another exemplary feature of this invention is a method of providing a clear separation of service delivery platform from the service offerings thereby leading to dynamic support for new offerings.

A further exemplary feature of this invention is a method of providing a true global delivery model based process automation with planning and scheduling component factoring location based holidays and work-time-zones in the planning process.

Yet another exemplary feature of this invention is a method of providing a service delivery management internationalization portal thereby providing a locale based view of the service order process.

Still another exemplary feature of this invention is a method of providing an optimized set of service offerings with parameterized and rule-based service plans.

Another exemplary feature of this invention is a method of providing a scalable competency based approach to service delivery.

A further exemplary feature of this invention is a method of organizing delivery capability along with optimal competencies based on an on-demand model.

Yet another exemplary feature of this invention is a method of providing a service delivery performance management platform modeled and monitored via Key Performance Indicators (KPIs) with support for notification on any violation of service level agreements.

Various other objects, features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF THE DRAWINGS

FIG. 1 illustrates a KPIs associated with Service Order business artifact according to an embodiment of the present invention.

FIG. 2 illustrates a business role that are interested in a particular KPI according to an embodiment of the present invention.

FIG. 3 illustrates a data source used for computing service order KPIs according to an embodiment of the present invention.

FIG. 4 illustrates a KPIs associated with Service Order Task business artifact according to an embodiment of the present invention.

FIG. 5 illustrates a business roles that are interested in Service Order Task KPIs according to an embodiment of the present invention.

FIG. 6 illustrates a data source used for computing service Order Task KPIs according to an embodiment of the present invention.

FIG. 7 illustrates a summary of all the potential situations of both high and low priorities for the service order delivery process according to an embodiment of the present invention.

FIG. 8 illustrates the situation and actions associated with Service Order Task KPIs.

FIG. 9 illustrates an operation model, ie. Map, for the service order according to an embodiment of the present invention.

FIG. 10 illustrates a primary business artifacts for a Service Order enablement according to an embodiment of the present invention.

FIG. 11 illustrates a lifecycle phases of a service order according to an embodiment of the present invention.

FIGS. 12, 13 and 14 illustrate a business operation model for a Service Order according to an embodiment of the present invention.

FIG. 15 illustrates a platform independent solution composition model according to an embodiment of the present invention.

FIG. 16 illustrates a service order observation model according to an embodiment of the present invention.

FIG. 17 illustrates a service order task observation model according to an embodiment of the present invention.

FIG. 18 illustrates an implementation map according to an embodiment of the present invention.

FIGS. 19 and 20 illustrate two dashboards according to an embodiment of the present invention.

FIG. 21 illustrates a flow chart according to an embodiment of the present invention.

FIG. 22 illustrates a hardware implementation for services delivery according to an embodiment of the present invention.

FIGS. 23 and 24 illustrate a software deployment implementation services delivery according to an embodiment of the present invention.

FIGS. 25A, 25B and 25C illustrate still another software deployment implementation for services delivery according to an embodiment of the present invention.

### DETAILED DESCRIPTION

The solution approach encapsulated in this invention is summarized below in the four steps below:

### Step 1: Specification of the strategic goals and objectives of the organization with respect to Service Order enablement

### Step 2: Specification of a Service Order enablement operation model and performance model that support these goals.

### Step 3: Generation and enhancement of a platform-independent solution composition model that enables the IT implementation of business operation

### Step 4: Implementation of a computer program driven by the solution model to process, manage, and monitor service requests.

Advantages of using this invention are as follows:

Outsourcers, both IBM and our competitors, have approached customer engagements indicating that delivery efficiency and optimization will be obtained by a transformation to a standard set of tools. This implies that the outsourcing provider has monolithic control over scope and architecture for the customer environment. The trend, however, is selective outsourcing, customer architectural control of IT solutions and account retention of legacy tools. Although the premise of optimization by standardization is still correct, the target environments are extremely heterogeneous and the ability to influence that is less an outsourcer dictate then in the past. We have a requirement for collaboration and dealing with heterogeneity. In addition our competitors are gaining market share by embracing the heterogeneity and selling what is known as “lift and shift”. This invention differentiates us in this outsourcer space. The value and IP of this invention is enabling IGS to deal with non-standard things in a standard way. It enables selective transformation and ROI driven adoption of standards.

Another way an embodiment of the present invention can summarized is with a modification of the above steps are listed as follows:

### Step 1: Specification of the strategic goals and objectives of the organization with respect to Service Order enablement

### Step 2: Specification of the Service Order enablement operation that supports these goals.

### Step 3: Generation and enhancement of platform-independent solution composition model that enables the IT implementation of business operations

### Step 4: Implementation of an IT solution on newScale and WBI SF.

Business performance model captures the Key Performance Indicators (KPIs), relationships between the KPIs, algorithms and data for computing the KPIs, business situations that are triggered by KPIs, and actions that need to be performed to remediate the situations.

Key Performance Indicators (KPIs) are quantifiable measurements, agreed to beforehand, that reflect the critical success factors of an organization. Typically, an organization uses KPIs to measure progress toward the organizational goals. Thus, KPIs vary depending on the type of business and the goals.

To capture a detailed definition of a KPI, the following KPI Template is introduced:

### KPI: (name)

### Description: (description of the KPI)

### Objective: (Purpose of the KPI)

Scope: (The level the KPI is created for, e.g. Service Order/Service Plan, Service Order Task)

### Definition: (How KPI is derived via referencing data fields in the source)

### Source: (Data fields and math formula to calculate the KPI; Access mechanism of how the KPI is obtained, e.g. via database access or messaging/events)

Data fields must be qualified by same set of dimensions

### SLA Objective/benchmark: (value objective specified in Service Level Agreement or known data value to be used as a baseline)

### Dimension: (Qualifying or grouping criteria for use with data fields)

Example dimensions:
Time—Point in time or Time interval: start date, end date, estimated date, target date, etc.
Performer Id—Id of the person who performs a task
   Org Id—Id of an organization
Service Id—Id of a service that the service order references
Account Id—Id of account of a customer
   Queue Id—Id of a work queue
Service type—category of a set of services
   Geography
   Industry

### Users: (persons/stakeholders who use and/or need the KPI)

### Usage Example: (Sample KPI usages)

Each KPI is qualified by one or more dimensions. For the data fields listed in the same source, if they are qualified by dimensions, they must be the same set. For example, if one of the data field uses time and performer Id as dimensions, all the related data fields used for calculation must also use the same time period and performer Id as dimensions.

A sample KPI definition using the above template is listed below:
ServiceRequestVolume
Description:
   Total number of a service requested
Objective: Track most frequently requested service(s)
Scope: Plan level
Definition: Calculate the volume of a particular service requested
Source:
   Start date, End date
   Org Id
   Service Id
   Account Id
   Calculation: Total number of this SRs is the sum of all service requests qualified by the dimensions
Suggested benchmark/Range: TBD
Dimension:
   Time Period
   Org Id
   Service type
   Account Id
Example:
Track the five most frequently requested services or 5 least frequently requested services.

### Service Order KPIs

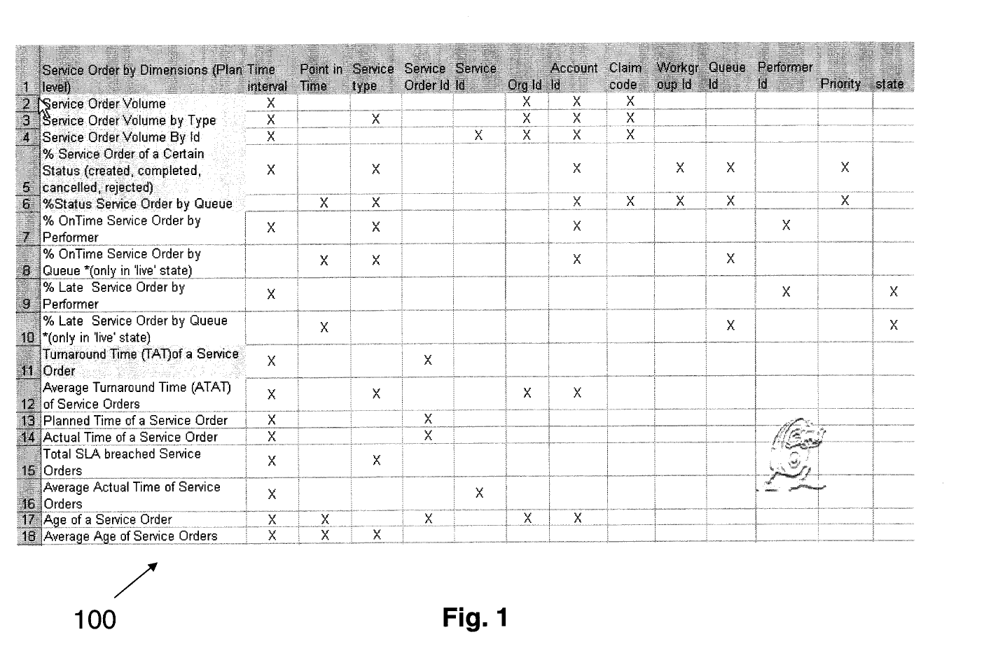

KPIs are organized by the business artifacts. FIG. 1 lists KPIs associated with Service Order business artifact and shows the dimensions in which a particular KPI is applicable. For example, Service Order Volume is a KPI that is computed by time intervals, service delivery organizations, accounts, and claim codes

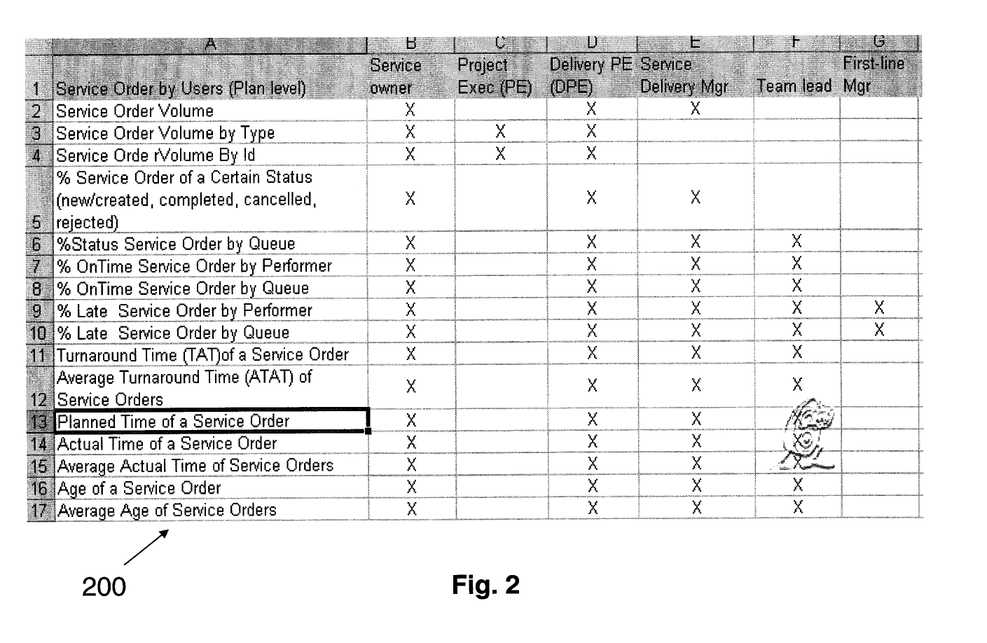

FIG. 2 shows the business roles that are interested in a particular KPI. For example, Service Order Volume is of interest to Service Owner, DPE, and Service Delivery Manager. This information is important to design role-based business dashboards. For example, the business dashboard of the Project Executive should show Service Order Volume by type and ID, while the business dashboard for a manager at a service provider organization should show the percentage of late service orders by performer and by queue.

Service order KPIs are computed from data contained in service order artifact instances and from temporal data collected when the service order tasks are executed.

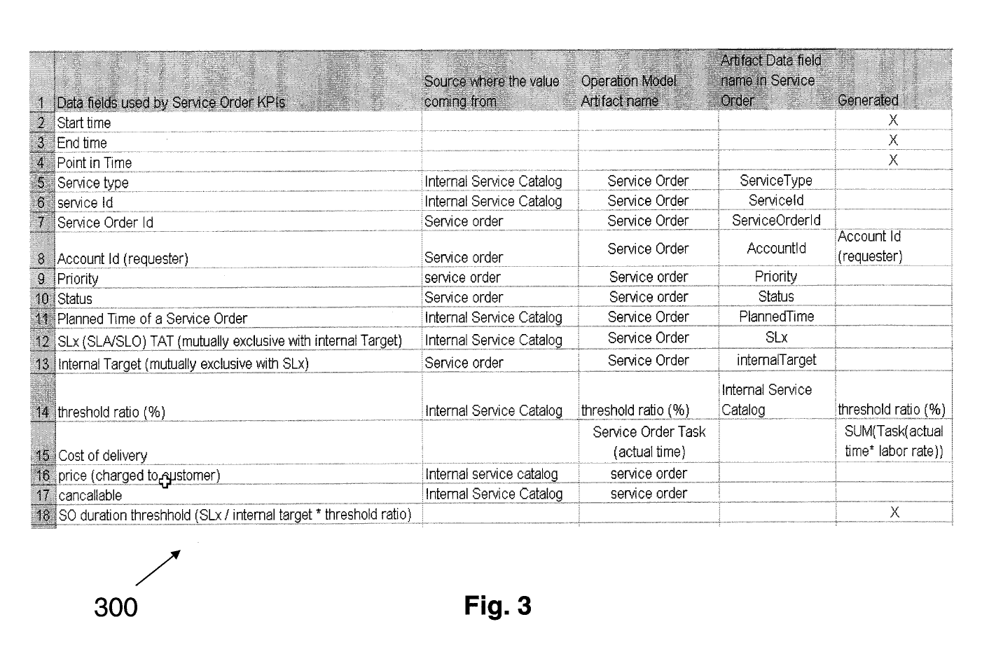

FIG. 3 shows the data sources used for computing service order KPIs. The table describes a mapping among 1) the data fields used by Service Order KPIs, 2) where the values are coming from, e.g. service catalog or a service order, 3) artifact name in the model, e.g. Service Order, 4) corresponding data field name in the artifact, 5) where the values are stored at runtime.

### Service Order Task KPIs

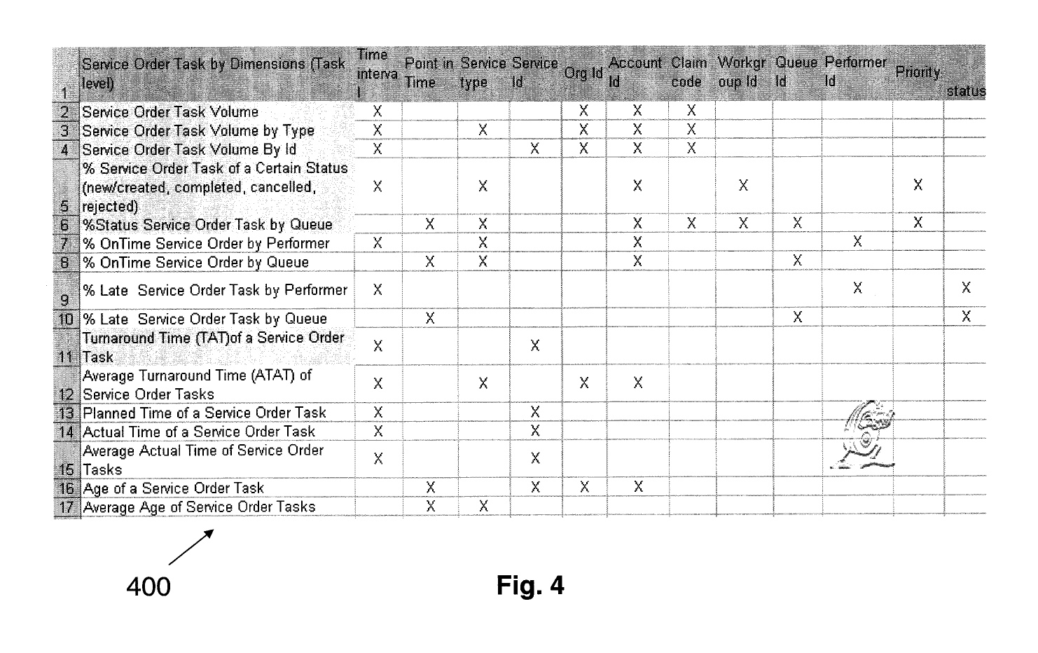

FIG. 4 lists KPIs associated with Service Order Task business artifact and shows the dimensions in which a particular KPI is applicable. For example, Service Order Task Volume is a KPI that is computed by time intervals, service delivery organizations, accounts, and claim codes.

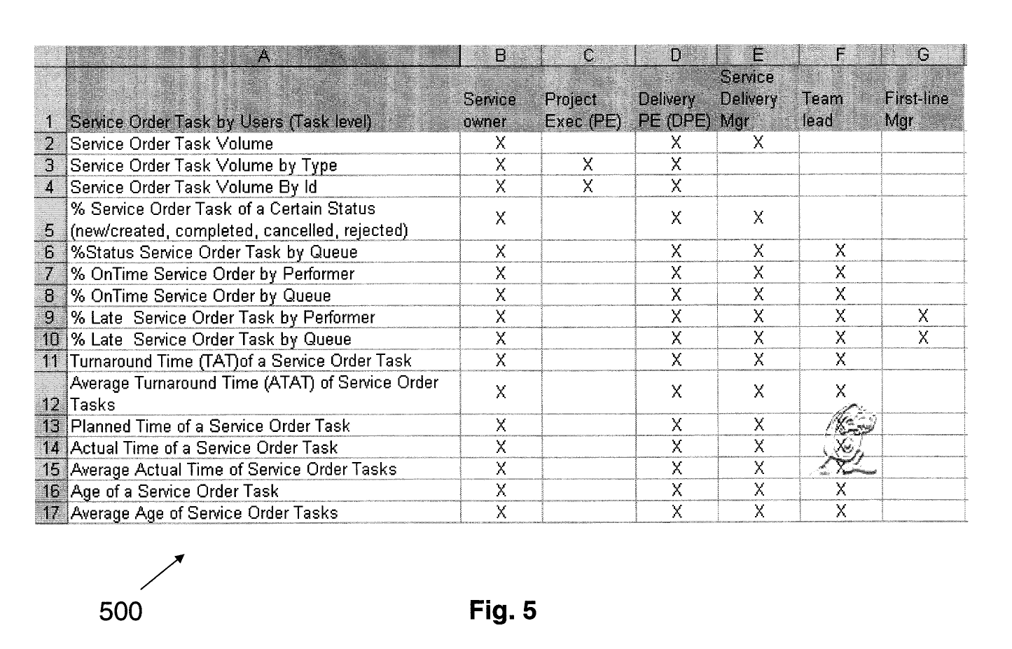

FIG. 5 shows the business roles that are interested in Service Order Task KPIs.

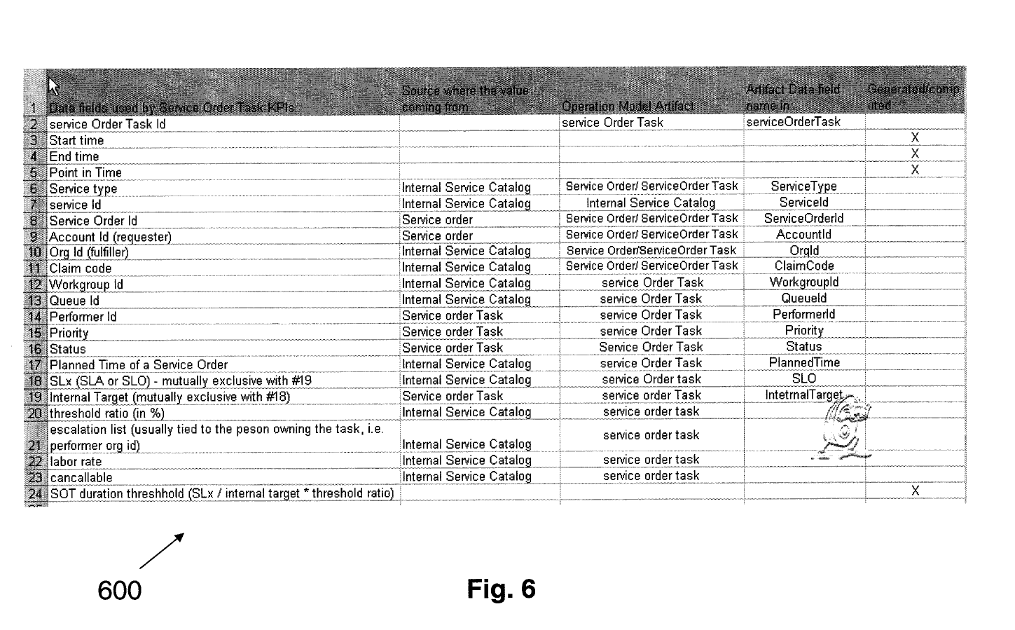

FIG. 6 shows the data sources used for computing service Order Task KPIs.

### Business Situation

A business situation is defined as logical condition over a set of KPIs and/or metrics.

Mostly, a situation is simply binary metric of which value is either true or false. The definitions of situations are also related to organizational goals. A negation of a goal is likely to be defined as a situation. For example, the goal of 80% on time service Order by queue in a quarter can be translated into a situation, e.g. the on time percentage by queue is less than 80% in the quarter, if a company attempts to manage its business by exceptions.

In actuality, situations each account wants to track can vary widely, and it would difficult to make them uniform. That is, depending on the priority, an account may want to track a certain subset of all potential situations that can occur based on the list of KPIs. Please refer to the section that follows for a summary of all the potential situations for the service orders.

To capture the details of the definition of a business situation, a situation template is created for that purpose as follows:

### (Template)

### Situation: (name)

### Description: (description of the situation)

### Objective: (Purpose of the situation)

Priority: (priority of the situation: high, medium, low)

### Evaluation Frequency: (one time only, Periodical, whenever)

KPIs involved: (one or more KPIs that defines this situation)

### Situation Rule:

### Decision-making:

### Actions: (email, dashboard, etc . . . )

### Expiration Time: (Time when this situation is expired)

Ex: one time only—expires at the specified time
Periodical—expires when the duration ends
Whenever—expires when the duration ends

### Situation Consumers: (persons who will be notified when a situation occurs)

### Usage Example: (Sample situation usages)

An example of a high priority business situation for Service Delivery is described as follows:

Example: For Service orders, report “Service Order elapse time exceeding threshold situation”. For the ‘planned time’ of a Service Order, e.g. 20 hours, evaluate the exceeding threshold situation when 90% time has past since the SO is created, i.e. 18 hr, alert if the service order is not yet completed.

### Situation: Elapse time exceeding threshold situation

### Description: Elapse time exceeds a certain percentage of the planned time situation

### Objective: Monitor if the Turnaround Time threshold exceeds what is specified by SLx (SLA or SLO) or by internal target by a certain percentage or threshold ratio

### Priority: high

KPIs involved: Elapse time of a Service Order
Situation Rule: when elapse time is 90% of a Service Order planned time, which is calculated using the following formula:

90%*planned time of a service order

### Decision-making: notify personnel to perform root cause analysis

### Actions: email

### Expiration Time: expires at the end of daily period

### Situation Consumers: (persons who will be notified when a situation occurs)

### Usage Example: For a planned time of a service order, e.g. 20 hours, evaluate the exceeding threshold situation when 90% time has past since the SO is created, i.e. 18 hr, alert if the service order is not yet completed.

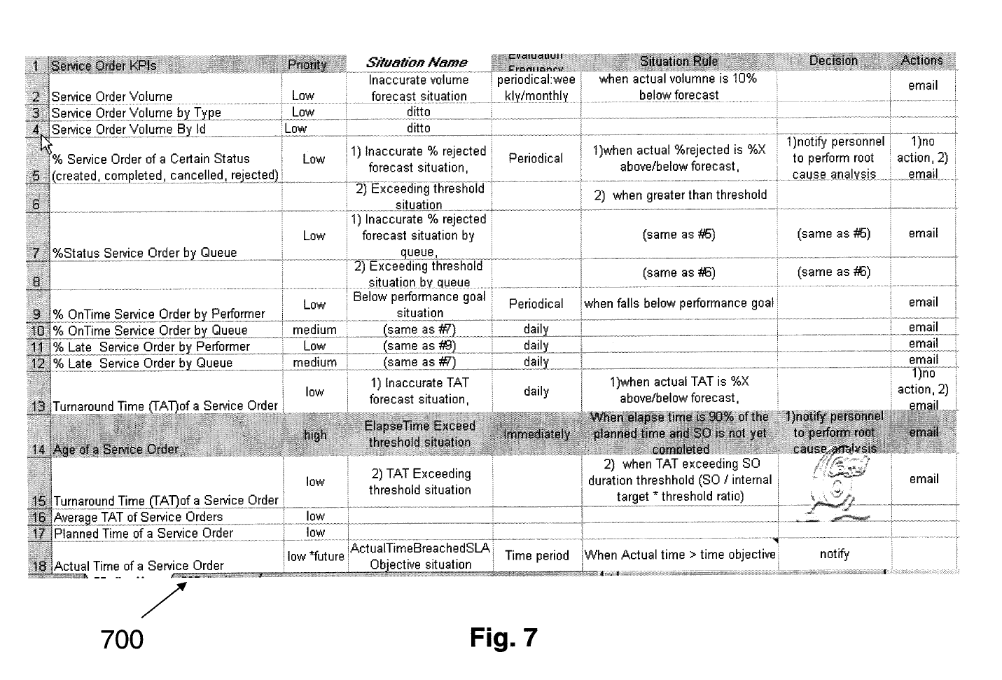

FIG. 7 shows a summary of all the potential situations of both high and low priorities for the service order delivery process. Each account may be able to tailor to its own priority to determine a subset of situations to be used. For example, “Elapsed Time Exceeded Threshold Situation” is caused when the elapsed time for provisioning a service order is 90% of the planned time and service order is not yet fully provisioned. This situation is triggered by the KPI “Age of a Service Order”. The action corresponding to this situation is e-mail notifications to stake holders.

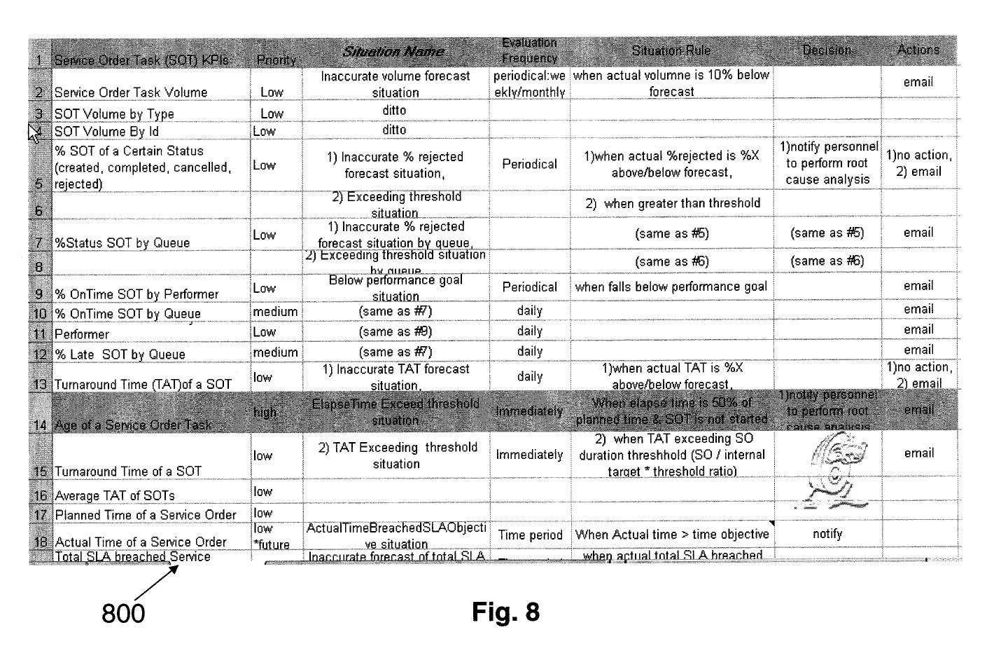

FIG. 8 shows the situations and actions associated with Service Order Task KPIs. For example, Elapsed Time Exceeds Threshold situation is triggered when elapsed time since a Service Order Task is ready is 50% of planned time and the Task are not yet started.

The following work products are created in this phase:

### KPI Template and KPIs

### KPI and Artifact Mapping

### Situations & actions

### BPM Operation model in WBI modeler

### Details of Step 2:

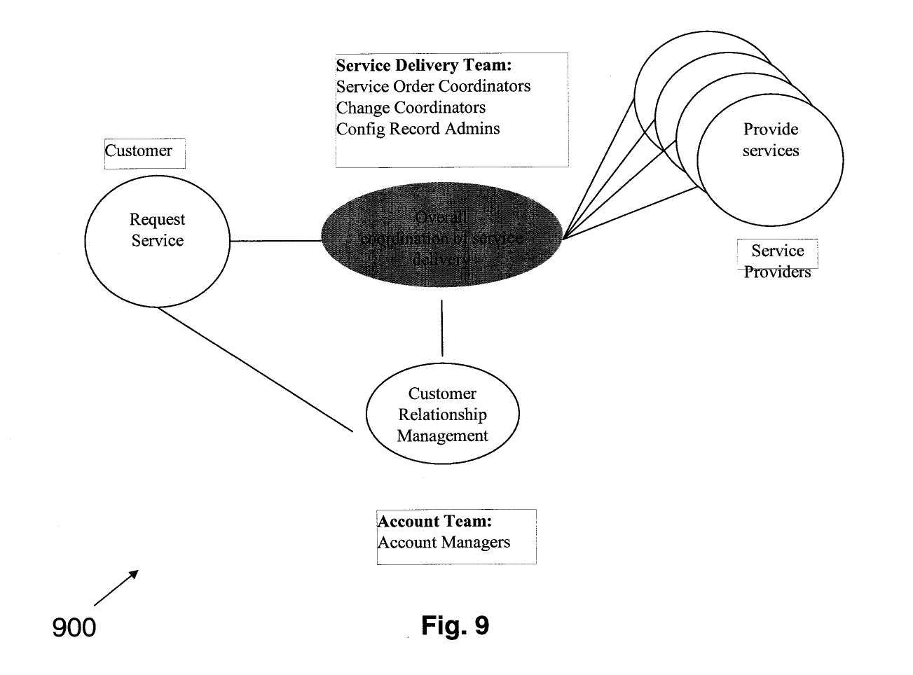

Referring to FIG. 9, shown is the operation model, ie. Map, for the service order.

Operation model 900 for Service Order enablement is a formal specification of the operations that create, consume, modify, or use business artifacts to manage the end-to-end lifecycle of a service order and perform the requested service.

There are four types of organizations that participate in this process:
1. The customer organization who creates service requests
2. The service delivery organization who coordinates the service delivery activities
3. The account team that manages the customer account for the service provider
4. Service provider organizations who serve as clients to the primary service provider

The focus of the operational model 900 is on the tasks being performed by the Service Delivery team to manage the service order and coordinate the service delivery with Service Provider teams, account teams, and customers.

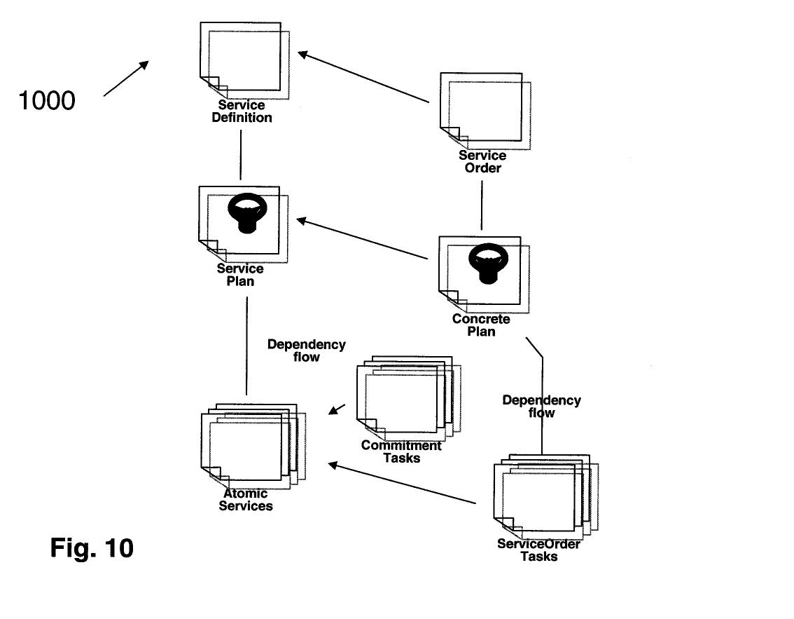

FIG. 10 shows the primary business artifacts 1000 for Service Order enablement. These are discussed in detail below.

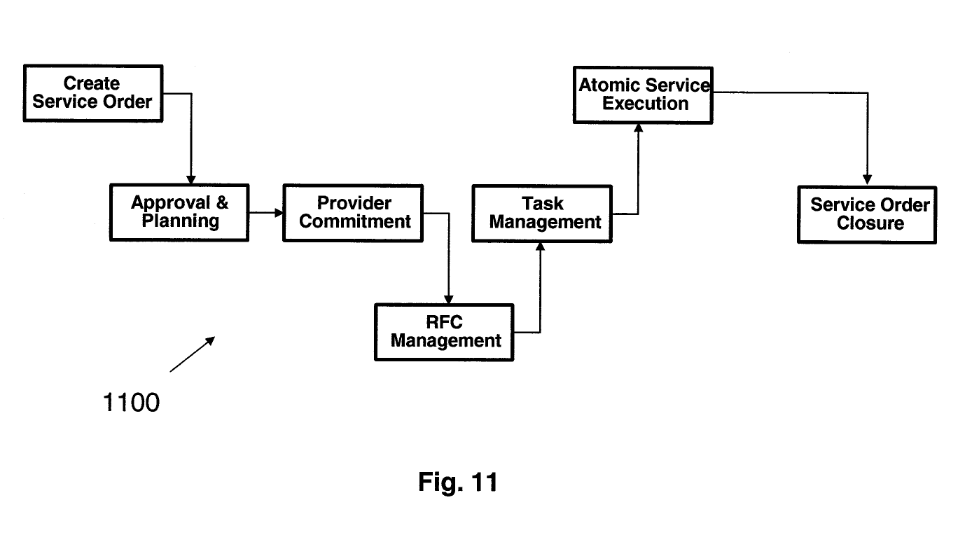

Service Order is the key business artifact that drives the Service Order enablement. FIG. 11 shows the lifecycle phases 1100 of a service order. A service order is created when the Service Delivery team receives a service request from a customer. Service delivery organization maintains an internal catalog of Service Definitions for all services it provides to its customers. A service definition refers to a Service Plan that defines the work breakdown structure for the work that needs to be performed for provisioning the order. The work breakdown structure is a tree structure and the leaf nodes of this tree are the Atomic Services.

The service request received from the customer is correlated with the appropriate service definition in this internal catalog. Next it goes through an approval process and if approved, a Concrete Plan is created to provision the service request. The plan identifies the tasks that need to be performed and the service providers who perform these tasks. This plan is created using the service plan, but customizes the plan to suit the specific service order instance. Next, service delivery team negotiates with the service providers and the account team to secure commitments and finalize the plan. A Commitment Task is created for each commitment that needs to be secured. If change management is needed, a change request is created and change management process kicked off. Change management is outside the scope of the Service Order enablement operation model and hence we do not list Change Request as an artifact. Instead, we send a service request to a change management service. Once change is approved, Service Order Tasks are created from the concrete plan in the Service Order. Each Service Order Task corresponds to the Atomic Services that make up the Service Plan. As part of completing the Service Order Task, atomic services are executed. When all the work is done satisfactorily, service order is closed.

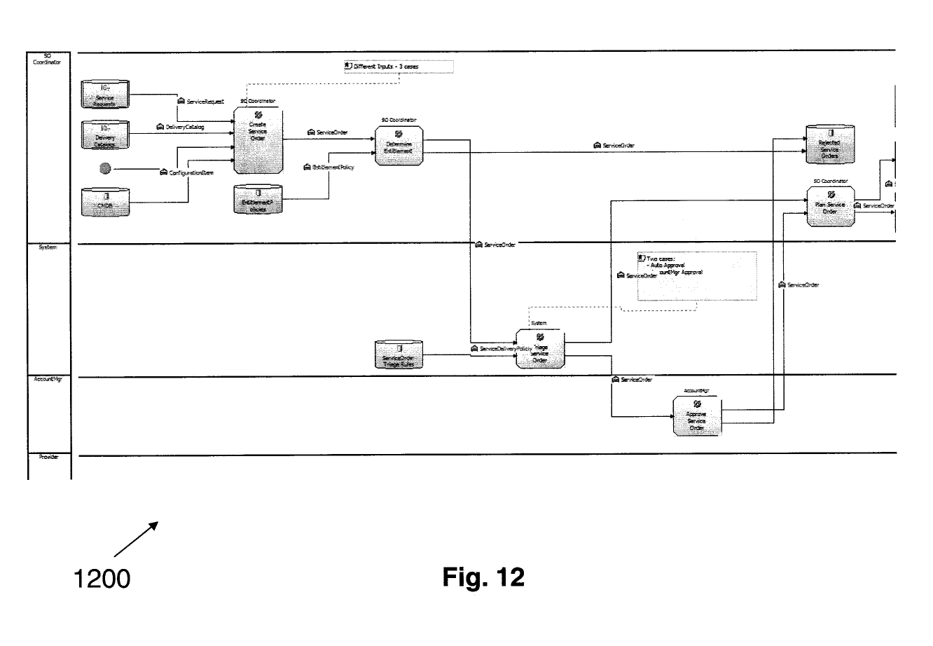

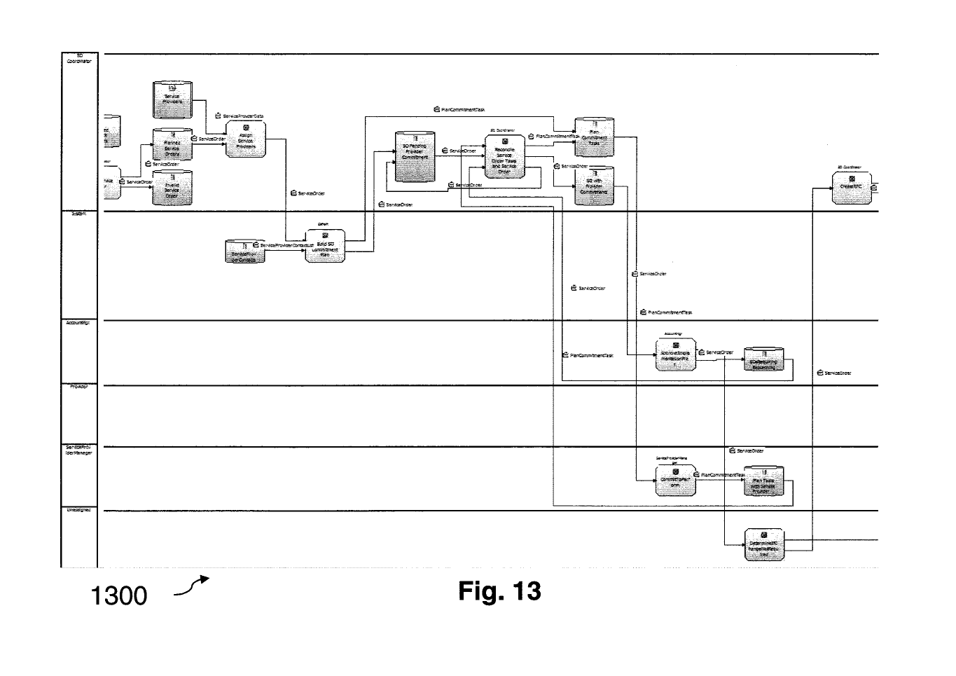

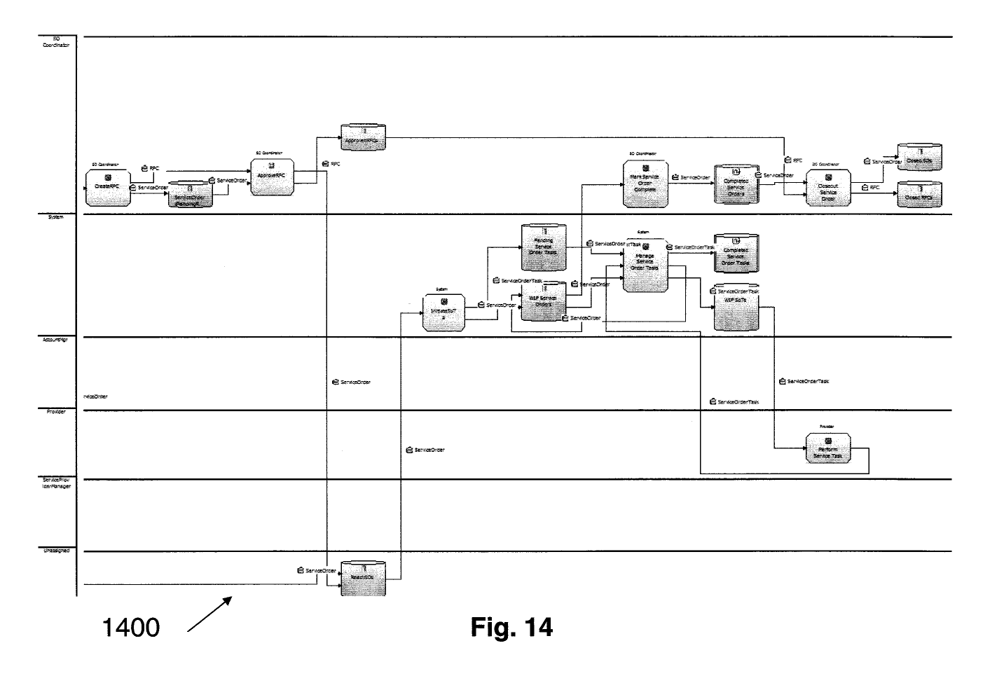

FIGS. 12, 13, and 14 show the business operation model for Service Order enablement, 1200, 1300 and 1400, respectively. It shows all the business tasks being performed for service order enablement, identifies the business roles performing these tasks, and identifies the business artifacts used by each task.

This operation model is created using WBI Modeler.

### Details of Step 3:

Next step in the transformation process is to create a platform-independent UML model of the Service Request process. Creation of the platform-independent model comprised of several key steps:

Generation of initial solution model from the BOM model: Using WBI2UML MDBT plugins an initial UML solution model was auto-generated for the Service Request process from the Operation Model. This includes ABOs, resources, data model, default views/list-views, action stubs, and use cases.
Augmentation of the initial solution model: An augmented solution model was created as an extension to the generated mode, to incorporate:
Specific customization to the views/list-views for various roles.
External service linkages (mapping of action stubs to service invocations) to the following services:
   Catalog service
   Triage service
   Reconciliation service
   Plan management service
   Entitlement service
   Notification service
   Task management service
   Atomic Services

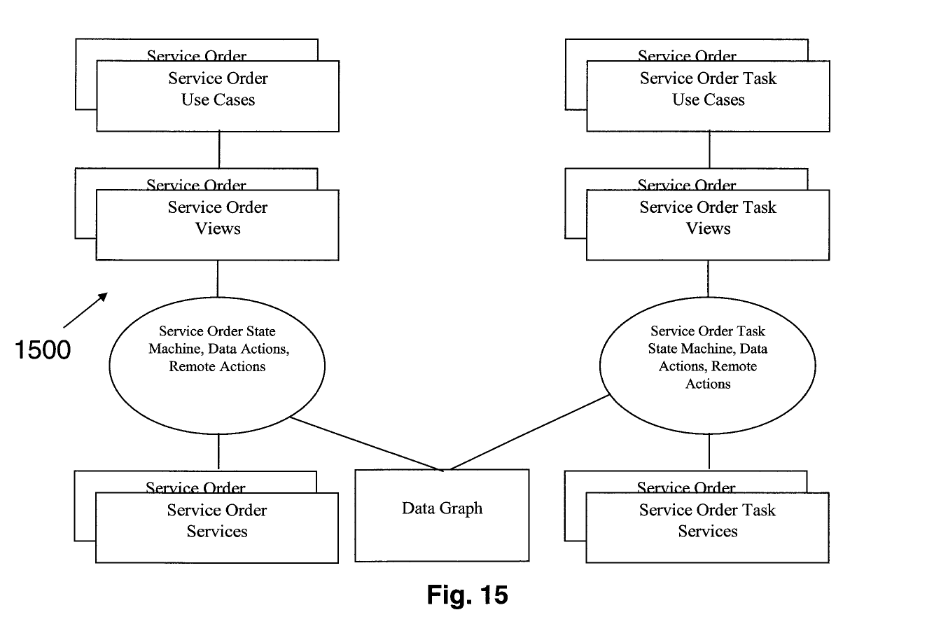

ABOs are at the heart of the solution model. ABOs are automatically generated from the operation model by a computer program. This program examines the business artifacts in the operation model and identifies artifacts that undergo lifecycle changes. The program generates an ABO for each such artifact. For service order enablement process, Service Order and Service Order Task are modeled as ABOs in the solution model. Tasks in the operation model are mapped to Use Cases. Views are created to support the Use Cases. The Views are then associated with appropriate ABOs. Behavior of each ABO is defined using a state machine. Transition actions of the state machine are associated with data actions and remote actions. A data graph is used to model the information content in all of the artifacts. Data actions are facilitated with the data graph and remote actions are mapped to service invocations. FIG. 15 shows a graphical rendering 1500 of these elements.

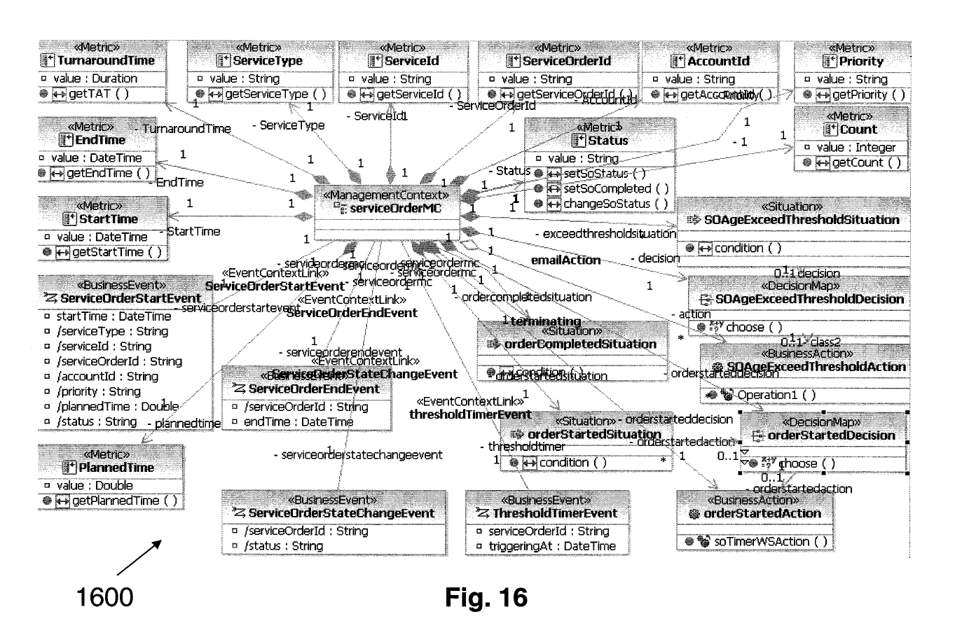

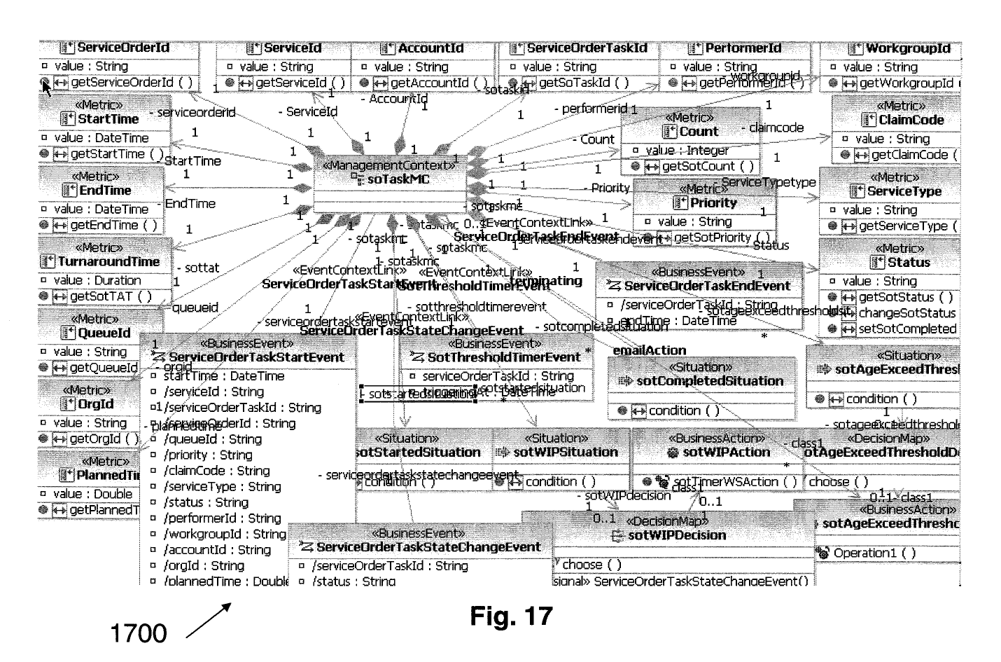

In addition to the solution model, we define a UML-based observation model to formally capture the KPIs, Situations, and Actions described in the earlier section. FIG. 16 and FIG. 17 show the observation models for Service Order 1600 and Service Order Task 1700, respectively.

Rational Software Architect (RSA) is used to model the solution model in UML. MDBT Toolkit is used to define a profile in RSA to enforce the necessary constraints to create a semantically and syntactically correct solution model. MDBT Toolkit is also used to autogenerate the initial solution model from the business operation model.

### Details of Step 4:

Once a platform-independent solution is created, next step is to implement the solution on a specific target platform. The target platform is a combination of middleware products and applications. The target platform for the PoT is a combination of WebSphere Business Integration Server Foundation (WBI-SF), newScale, eESM, ITSM Change Management, DB2 AlphaBlox, and TPM. We take the following steps to create an implementation:
Autogeneration of code for WBI-SF from the solution model using MDBT plug-in.
Manual implementation of the service components identified in the solution model on WBI-SF using WSAD-IE.
Modification and enhancement of generated UI code to create production-level UI code on WBI-SF.
BPM dashboard implementation on DB2 AphaBlox
Configuration of newScale, eESM, ITSM, and TPM
newScale connectors to integrate with WBI-SF code.
WBI-SF connectors to integrate with newScale & TPM
Database creation and setup on DB2 using the generated SQL scripts

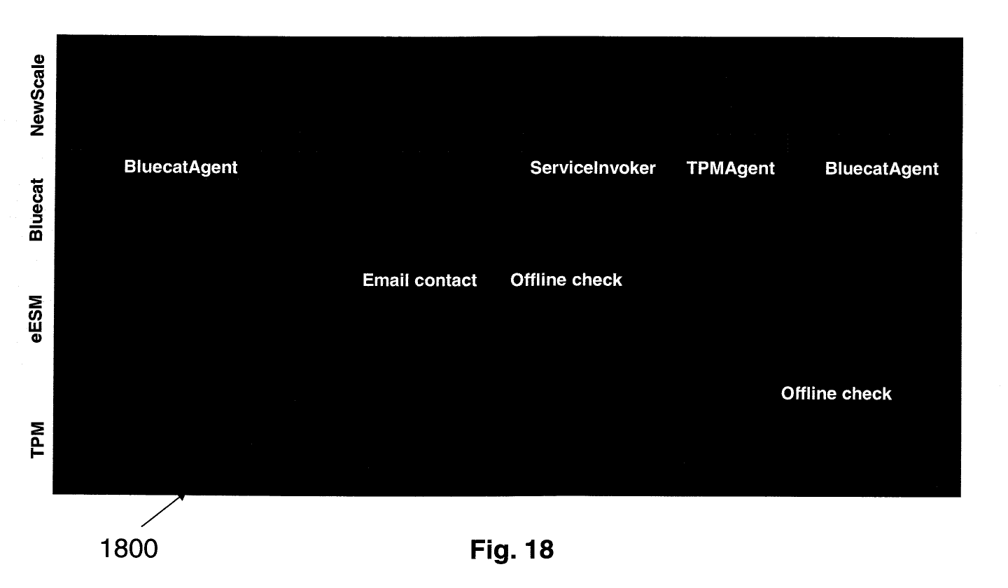

The work product from this phase is an operational prototype deployed on WBI-SF and integrated with newScale, TPM, eESM, and ITSM. This system is code named BlueCat. FIG. 18 shows the mapping 1800 of business operation model to newScale, WBI-SF, eESM, and TPM and the integration components between these systems.

### KPIs Used for BPM Dashboard

For the KPIs that were determined as relative low priority, which means no escalation of the situation is required, they will appear on the BPM Dashboard, which has periodical data refreshing rate as frequent as one or two minutes.

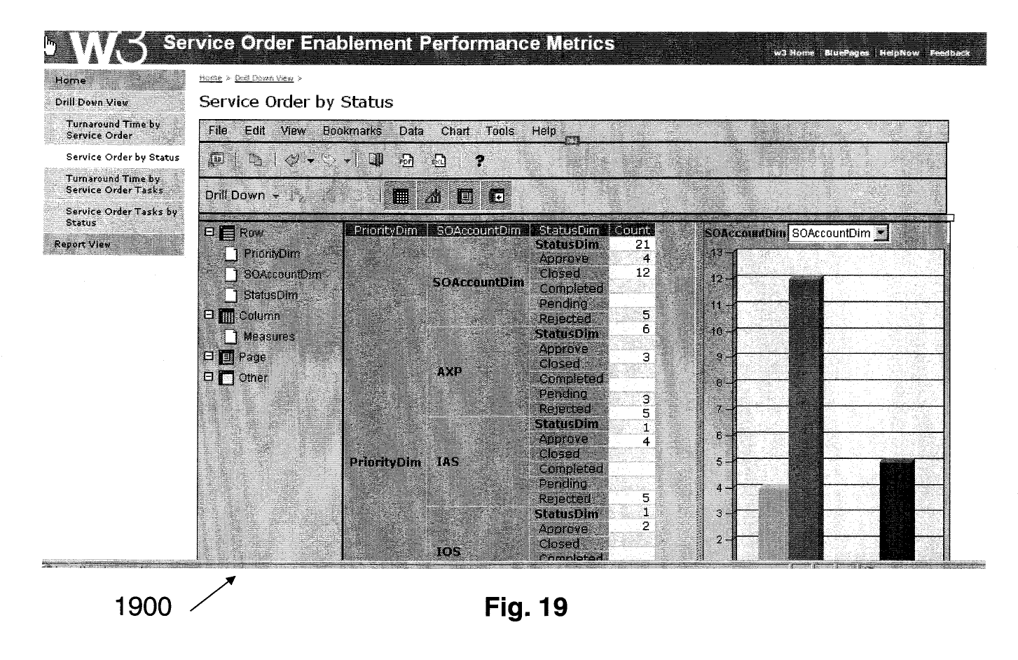

For details of what KPIs are designated for dashboard reporting, please see details of the highlighted KPIs of the FIG. 19 in the section “Service Order KPIs Summery by Dimension” for service order and in the section of “Service Order Task KPIs Summery by Dimension” for service order task.

### Sample Dashboards

FIG. 19 depicts a dashboard 1900 showing service order by status.

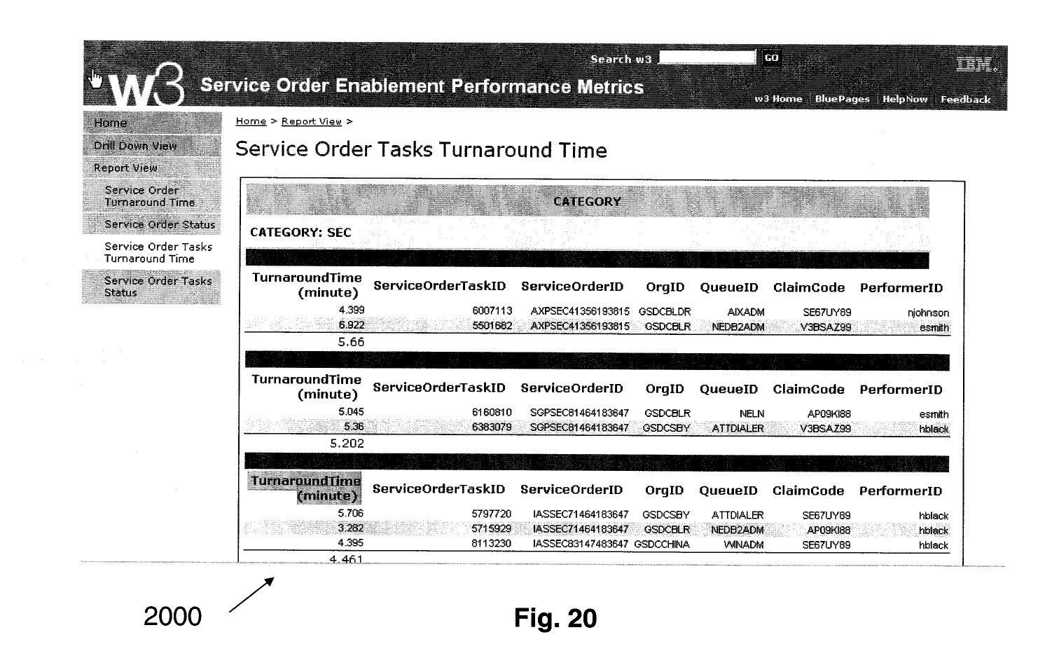

FIG. 20 depicts a dashboard 2000 showing a sample performance metric drill down capability using Alphabox for Service Order and service order task turnaround time.

The figure that follows depicts a sample performance metric reporting capability for Service Orders Tasks.

Additional embodiments of the present invention will be described with reference to the following figures.

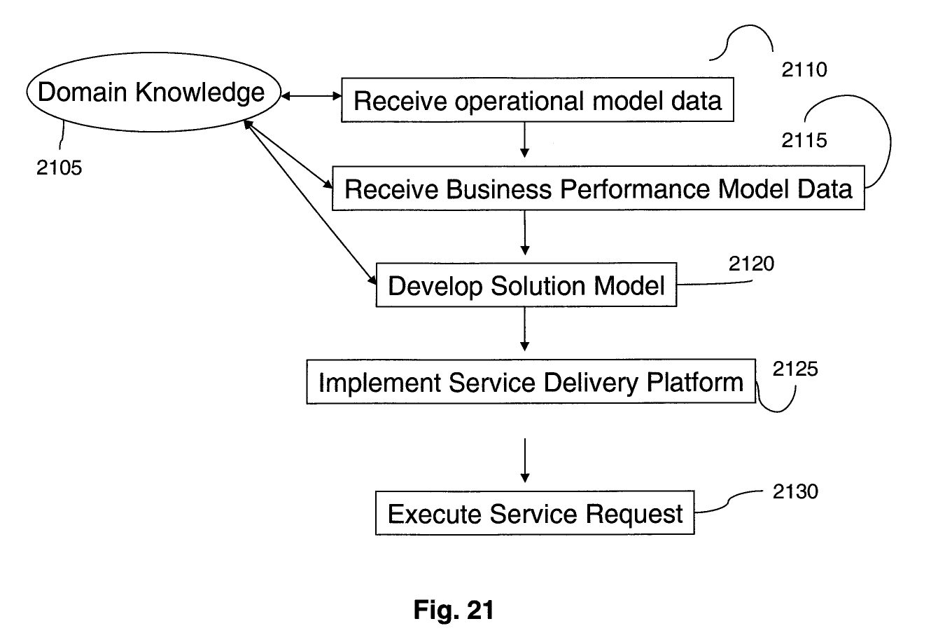

Referring to FIG. 21, shown is a flow chart according to yet another embodiment of the present invention. The steps of organizing a service request processing system requires the inputting of operational model data 2110, business performance model data 2115, and to develop a solution model 2120 from domain knowledge 2105. The solution model 2120 also receives data from other sources. Once the above information has been determined the system can implement the development of a service delivery platform 2125 to execute the processing of a service request 2130.

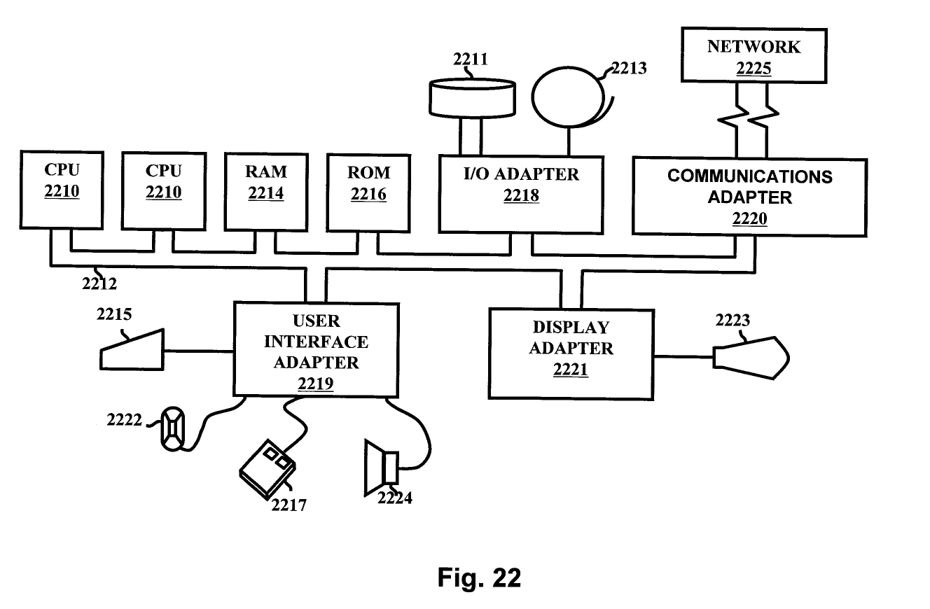

A representative hardware environment for practicing the embodiments of the invention is depicted in FIG. 22. This schematic drawing illustrates a hardware configuration of an information handling/computer system in accordance with the embodiments of the invention. The system comprises at least one processor or central processing unit (CPU) 2210. The CPUs 2210 are interconnected via system bus 2212 to various devices such as a random access memory (RAM) 2214, read-only memory (ROM) 2216, and an input/output (I/O) adapter 2218. The I/O adapter 2218 can connect to peripheral devices, such as disk units 2211 and tape drives 2213, or other program storage devices that are readable by the system. The system can read the inventive instructions on the program storage devices and follow these instructions to execute the methodology of the embodiments of the invention. The system further includes a user interface adapter 2219 that connects a keyboard 2215, mouse 2217, speaker 2224, microphone 2222, and/or other user interface devices such as a touch screen device (not shown) to the bus 2212 to gather user input. Additionally, a communication adapter 2220 connects the bus 2212 to a data processing network 2225, and a display adapter 2221 connects the bus 2212 to a display device 2223, which may be embodied as an output device such as a monitor, printer, or transmitter, for example.

It should also be obvious to one of skill in the art that the instructions for the technique described herein can be downloaded through a network interface from a remote storage facility or server.

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, visible light signals, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

Certain embodiments may be directed to a method for deploying computing instruction by a person or automated processing integrating computer-readable code into a computing system, wherein the code in combination with the computing system is enabled to perform the operations of the described embodiments.

At least certain of the operations illustrated in here in may be performed in parallel as well as sequentially. In alternative embodiments, certain of the operations may be performed in a different order, modified or removed.

Furthermore, many of the software and hardware components have been described in separate modules for purposes of illustration. Such components may be integrated into a fewer number of components or divided into a larger number of components.

Additionally, certain operations described as performed by a specific component may be performed by other components.

The data structures and components shown or referred to are described as having specific types of information. In alternative embodiments, the data structures and components may be structured differently and have fewer, more or different fields or different functions than those shown or referred to in the figures.

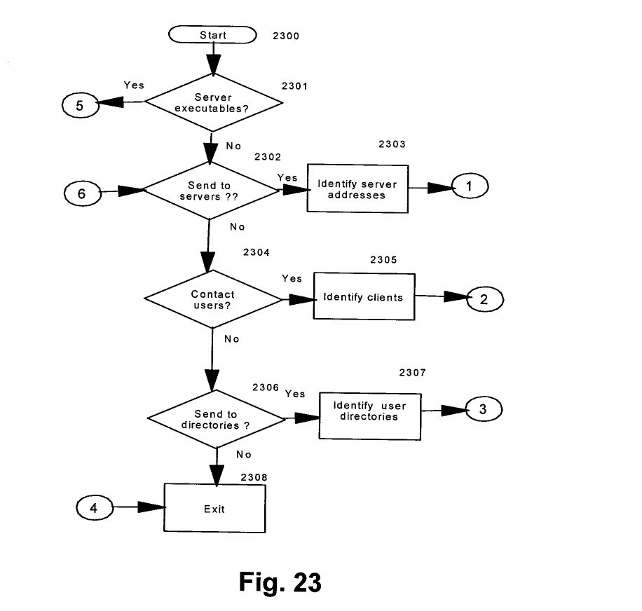

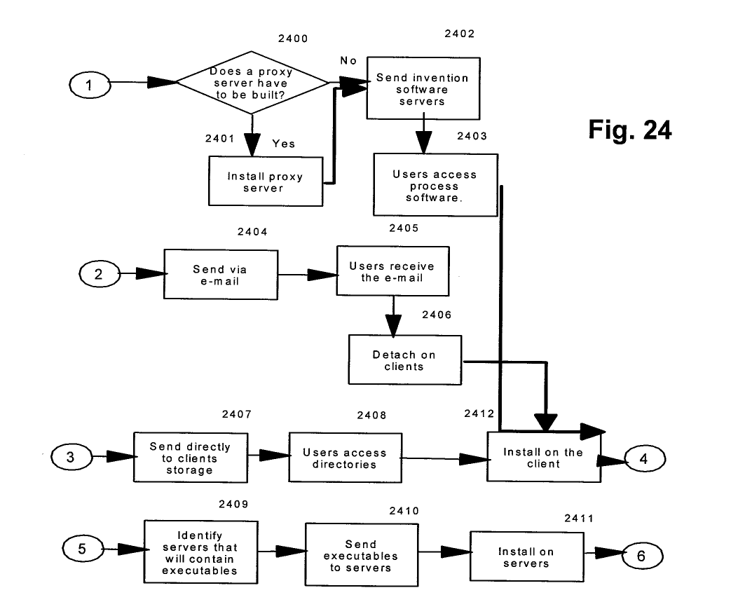

FIGS. 23 and 24 illustrate yet another software deployment implementation for using an embodiment of the present invention. Step 2300 begins the deployment of the process software. The first thing is to determine if there are any programs that will reside on a server or servers when the process software is executed 2301. If this is the case then the servers that will contain the executables are identified 2409. The process software for the server or servers is transferred directly to the servers' storage via FTP or some other protocol or by copying though the use of a shared file system 2410. The process software is then installed on the servers 2411.

Next, a determination is made on whether the process software is be deployed by having users access the process software on a server or servers 2302. If the users are to access the process software on servers then the server addresses that will store the process software are identified 2303.

A determination is made if a proxy server is to be built 2400 to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed 2401. The process software is sent to the servers either via a protocol such as FTP or it is copied directly from the source files to the server files via file sharing 2402. Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems 2403. Another embodiment is to have the servers automatically copy the process software to each client and then run the installation program for the process software at each client computer. The user executes the program that installs the process software on his client computer 2412 then exits the process 2308.

In step 2304 a determination is made whether the process software is to be deployed by sending the process software to users via e-mail. The set of users where the process software will be deployed are identified together with the addresses of the user client computers 2305. The process software is sent via e-mail to each of the users' client computers. The users then receive the e-mail 2405 and then detach the process software from the e-mail to a directory on their client computers 2406. The user executes the program that installs the process software on his client computer 2412 then exits the process 2308.

Lastly a determination is made on whether the process software will be sent directly to user directories on their client computers 2306. If so, the user directories are identified 2307. The process software is transferred directly to the user's client computer directory 2407. This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software 2408. The user executes the program that installs the process software on his client computer 2412 then exits the process 2308.

The present software can be further deployed to third parties as part of an additional service wherein a third party VPN service is offered as a secure deployment vehicle or wherein a VPN is build on-demand as required for a specific deployment. A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

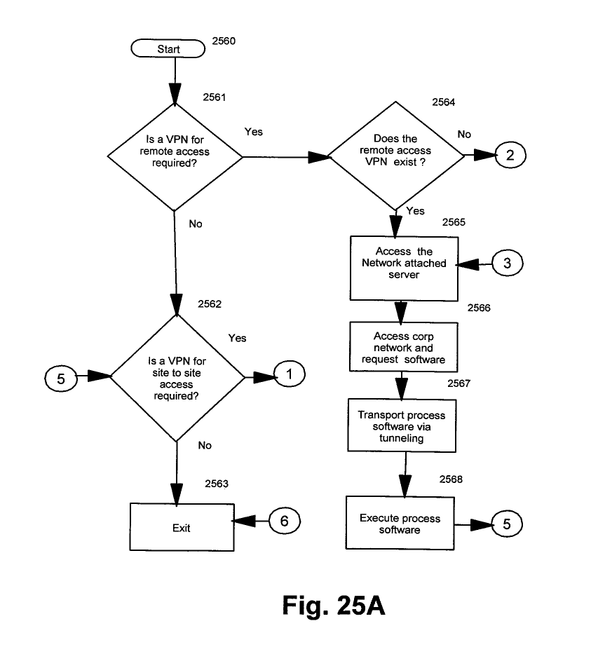

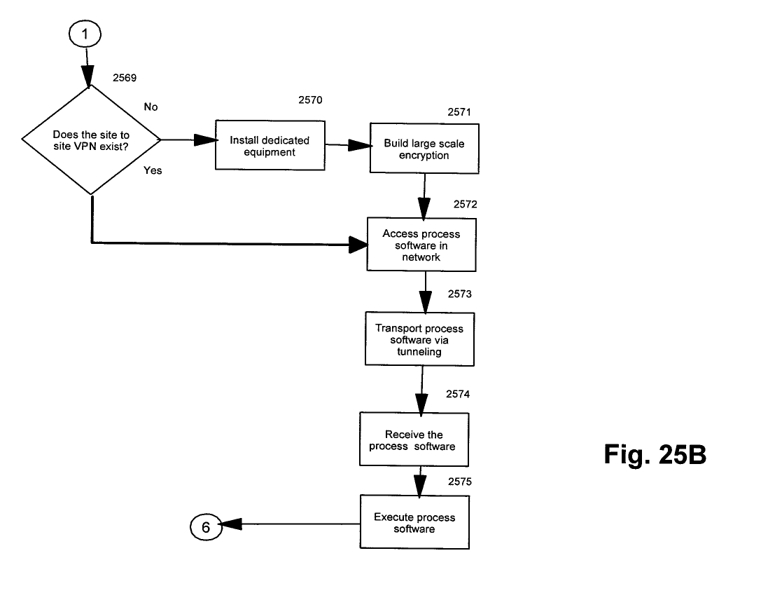

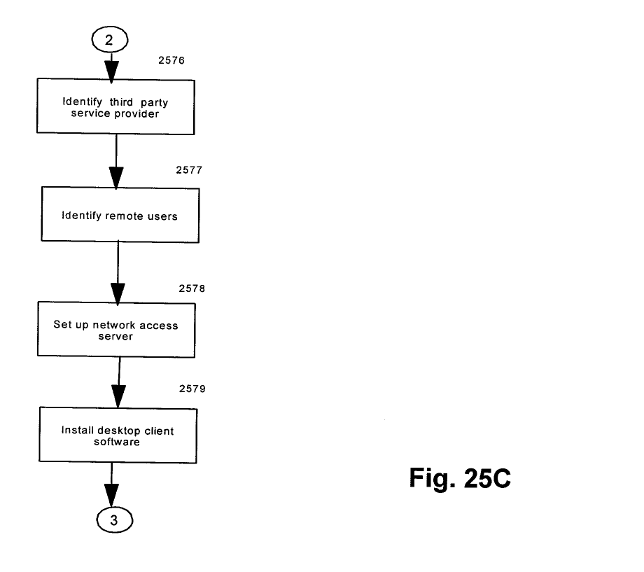

FIGS. 25A, 25B and 25C illustrate the VPN software deployment implementation for using an integrated approach in an end-to-end process according to an embodiment of the present invention. Step 2560 begins the Virtual Private Network (VPN) process. A determination is made to see if a VPN for remote access is required 2561. If it is not required, then proceed to 2562. If it is required, then determine if the remote access VPN exists 2564.

If a VPN does exist, then proceed to 2575. Otherwise identify a third party provider that will provide the secure, encrypted connections between the company's private network and the company's remote users 2576. The company's remote users are identified 2577. The third party provider then sets up a network access server (NAS) 2578 that allows the remote users to dial a toll free number or attach directly via a broadband modem to access, download and install the desktop client software for the remote-access VPN 2579.

After the remote access VPN has been built or if it been previously installed, the remote users can access the process software by dialing into the NAS or attaching directly via a cable or DSL modem into the NAS 2565. This allows entry into the corporate network where the process software is accessed 2566. The process software is transported to the remote user's desktop over the network via tunneling. That is the process software is divided into packets and each packet including the data and protocol is placed within another packet 2567. When the process software arrives at the remote user's desktop, it is removed from the packets, reconstituted and then is executed on the remote users desktop 2568.

A determination is made to see if a VPN for site to site access is required 2562. If it is not required, then proceed to exit the process 2563. Otherwise, determine if the site to site VPN exists 2569. If it does exist, then proceed to 2572. Otherwise, install the dedicated equipment required to establish a site to site VPN 2570. Then build the large scale encryption into the VPN 2571.

After the site to site VPN has been built or if it had been previously established, the users access the process software via the VPN 2572. The process software is transported to the site users over the network via tunneling. That is the process software is divided into packets and each packet including the data and protocol is placed within another packet 2574. When the process software arrives at the remote user's desktop, it is removed from the packets, reconstituted and is executed on the site users desktop 2575. Proceed to exit the process 2563.

It is to be understood that the provided illustrative examples are by no means exhaustive of the many possible uses for my invention.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the embodiments described above, but encompasses any and all embodiments within the scope of the following claims:

We claim:

1. A method for organizing a service request processing system, comprising:
receiving operational model data from domain knowledge
receiving business performance model data from said domain knowledge
developing a solution model based upon said domain knowledge and other data
and implementing a service delivery platform to execute a service request for processing said service request.

2. The method of claim 1 further comprises:
providing a clear separation of service delivery platform from the service offerings thereby leading to dynamic support for new offerings.

3. The method of claim 1 further comprises:
providing a true global delivery model based process automation with planning and scheduling component factoring location based holidays and work-time-zones in the planning process.

4. The method of claim 1 further comprises:
providing a service delivery management internationalization portal thereby providing a locale based view of the service order process.

5. The method of claim 1 further comprises:
providing an optimized set of service offerings with parameterized and rule-based service plans.

6. The method of claim 1 further comprises:
providing a scalable competency based approach to service delivery.

7. The method of claim 1 further comprises:
organizing delivery capability along with optimal competencies based on an on-demand model.

8. The method of claim 1 further comprises:
providing a service delivery performance management platform modeled and monitored via Key Performance Indicators (KPIs) with support for notification on any violation of service level agreements.

9. Apparatus for organizing a service request processing system, the apparatus comprising:
at least one computer being configured to be operative to:
receive operational model data from domain knowledge,
receive business performance model data from said domain knowledge,
develop a solution model based upon said domain knowledge and other data,
and implement a service delivery platform to execute a service request for processing said service request.

10. The apparatus of claim 9 further comprises:
a dynamic runtime planning engine to convert and handle raw orders.

11. A computer-based method for an electronic service offering, comprising:
receiving operational model data from domain knowledge
receiving business performance model data from said domain knowledge
developing a solution model based upon said domain knowledge and other data
and implementing a service delivery platform to execute a service request for processing said service request.

12. The method of claim 11 further comprises:
providing a clear separation of service delivery platform from the service offerings thereby leading to dynamic support for new offerings.

13. The method of claim 11 further comprises:
providing a true global delivery model based process automation with planning and scheduling component factoring location based holidays and work-time-zones in the planning process.

14. The method of claim 11 further comprises:
providing a service delivery management internationalization portal thereby providing a locale based view of the service order process.

15. The method of claim 11 further comprises:
providing an optimized set of service offerings with parameterized and rule-based service plans.

16. A program storage device readable by a machine, tangibly embodying a program of instructions executable by the machine to perform a method comprising:
receiving operational model data from domain knowledge
receiving business performance model data from said domain knowledge
developing a solution model based upon said domain knowledge and other data
and implementing a service delivery platform to execute a service request for processing said service request.
